(19) United States
(12) Patent Application Publication
(10) Pub. No.: US 2011/0250836 A1
(43) Pub. Date: Oct. 13, 2011

(54) INTERFERENCE-ADAPTIVE UWB RADIO-BASED VEHICLE COMMUNICATION SYSTEM FOR ACTIVE-SAFETY

(75) Inventors: Ratul K. Guha, Kendall Park, NJ (US); Wai Chen, Basking Ridge, NJ (US)

(73) Assignee: Telcordia Technologies, Inc., Piscataway, NJ (US)

(21) Appl. No.: 12/757,078

(22) Filed: Apr. 9, 2010

(51) Int. Cl. H04B 7/24

(52) U.S. Cl. 455/39

(57) ABSTRACT

A system and method for increasing transmission concurrency amongst communicating vehicles using UWB radio-based communication is presented. The method comprises dividing an area around a sending vehicle into transmission areas, and, for each transmission area, broadcasting a message from the sending vehicle, waiting for a time, and when a not clear to send response is not received, sending information to the transmission area, and the information being sent using a time-hopping sequence based on a location and seed in the message. The message can also have a frame length and a target region. The method can also comprise determining, when a no-send is received, whether the no-send was in response to the message from the sending vehicle, and when the no-send is not in response to the message from the sending vehicle, sending the information to the transmission area. The system and method can be used for active-safety vehicle communication.

### FIELD OF THE INVENTION

The present invention relates generally to automotive telematics, car-to-car communication, driving assistance, and traffic safety.

### BACKGROUND OF THE INVENTION

Several methods have been proposed to use and/or modify Wireless Access in Vehicular Environments (WAVE) to address vehicular active-safety applications. Sensor based systems such as millimeter radar are commonly used for detecting surrounding objects. Ultra-wide band (UWB) sensors at greater than 20 Ghz have been proposed for object detection for safety purposes. UWB radios have been envisioned and tested for communication inside the vehicle as an alternative to bluetooth. UWB pulses have been conceptualized for vehicle to vehicle communication. The effect of doppler shift on bit-error rate due to moving vehicles on monocycle and gaussian pulses for UWB has been investigated. One study, for example, compares the suitability of monocycle pulses versus coded gaussian pulses.

Existing solutions for safety communication rely on narrow-band dedicated short-range radio communication (DSRC). The basic medium-access mechanism involves carrier sensing with collision avoidance. Due to the significantly higher range of DSRC, significant interference can result in a neighborhood of vehicles. A mutual exclusion mechanism, such as requiring vehicles in a large area to remain silent for a communication session, is needed to enable DSRC to proceed. Thus, for a broadcast situation, numerous collisions limit the applicability of the proposed solutions. This hampers active neighborhood awareness applications.

Current proposed methods for safety communication involve carrier sensing and result in significant collisions. Moreover, the setup time can be significant, hampering active safety that stipulates 100 ms time-bound. Accordingly, there is a need for a method to provide vehicular active-safety applications with minimal interferences among vehicles.

### SUMMARY OF THE INVENTION

The inventive system and method provides a mechanism that increases transmission concurrency amongst communicating vehicles and supports adaptive communication between vehicles. The inventive communication methodology can enable neighborhood safety applications, assisted driving, cooperative braking, etc. The inventiveness of the approach includes adapting the merits of ultra-wide bandwidth radios to the needs of a vehicular safety system. To this effect, a communication protocol leverages time-hopping pulse mechanisms to address spatial specificity of an active-safety application. Typically, information is sent between vehicles over a mutually known time-hopping sequence. The inventive method also captures the nature of information exchanged among vehicles, including information which is periodically sampled from automotive driving systems, on-board sensors and units, GPS systems, etc.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates the difference between narrowband WAVE and wide-band radios;

FIG. 2 shows the PPM operation of an UWB radio;

FIG. 3 shows the SYNCH frame format initiated by a sender;

FIG. 4 shows the partitioned area around a transmitter;

FIG. 5 is a flow diagram to trigger the operation to send information;

FIG. 6 is a flow diagram of the send information operation of the invention;

FIG. 7 is a flow diagram of the process at a vehicle receiving information;

FIG. 8 shows a heuristic that can be used at vehicles to gauge potential interference caused by data transmission;

FIG. 9 shows another embodiment of the send information operation of the invention; and

FIG. 10 shows another embodiment of the process at a vehicle receiving information.

### DETAILED DESCRIPTION

An inventive method to use wideband radios for neighborhood communication between multiple vehicles is presented. The inventiveness of the approach includes adapting the merits of ultra-wide bandwidth radios to the needs of a vehicular safety system. Unique features of wideband radios have been matched to communication requirements amongst moving vehicles. The communication requirements drive the functioning of the novel protocol while leveraging the characteristics of UWB radios.

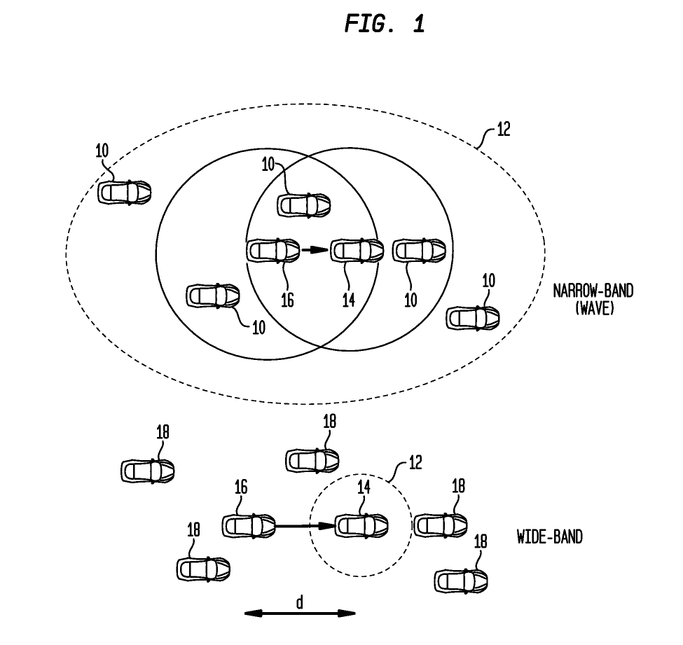

FIG. 1 schematically shows the difference between narrow-band WAVE and wide-band, e.g., UWB, radio communication capabilities. The dashed lines depict the region of mutual exclusion 12, that is, vehicles 10 in the dashed area need to remain silent and/or to back-off when an ongoing transmission is in progress between other vehicles 14, 16 in the area 12. As can be seen from FIG. 1, for the narrow-band case (top), the region of mutual exclusion 12 is quite large, nominally twice the transmission range. Moreover, the exclusion is enforced around both the receiver 14 and the transmitter 16 vehicles. In the wide-band case (bottom), the exclusion region 12 is a small area around only the receiver 14. Vehicles 18 outside this area, e.g., shown outside the dashed lines in FIG. 1 (bottom), need not remain silent while receiver 14 is receiving. In addition, silence or exclusion is only needed for the receiver vehicle 14. Thus, using UWB, more parallelism can be achieved. Further, for the wide-band case, the size of the exclusion area 12 can be calculated based on communication parameters.

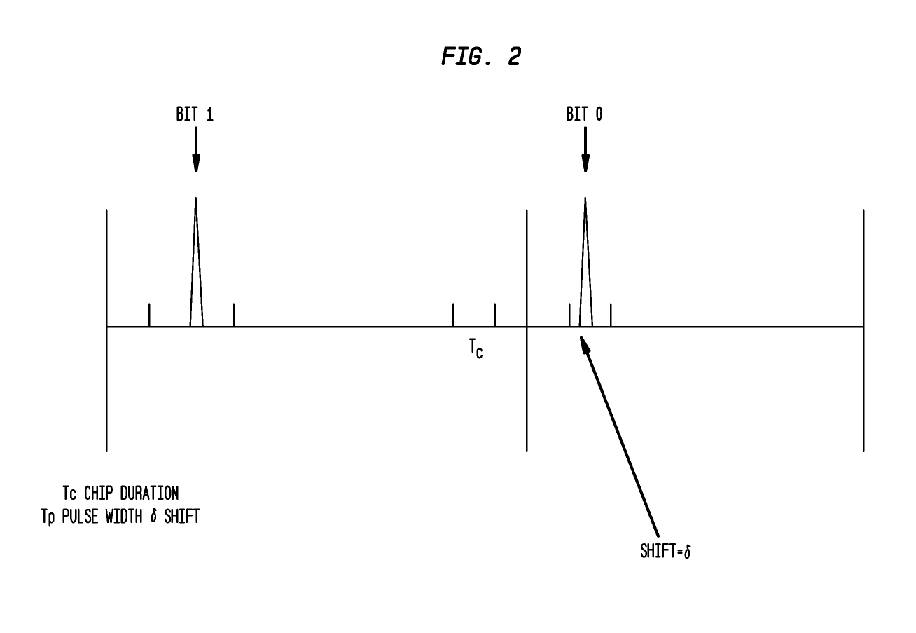

FIG. 2 shows the time-hopping pulse position modulation (PPM) mode of a UWB radio. A vehicle receiving a message or transmission, e.g., a receiver 14, “understands” and can interpret the bit based on the pulse position within a chip. A common pseudo-random number generator (PRN) determines the chip positions to be used for pulse transmissions. The chip positions comprise the time-hopping sequence (THS). The generator is seeded with a location hashed value for broadcast THS and a sender-based seed selection for data transmission. In the example on FIG. 2, two bits are sent. The receiver uses the seeded generator to determine the chips that will have data.

In the example shown in FIG. 2, the chip duration (Tc) is 0.2 nanoseconds at a pulse width (Tp) of 5 Ghz. Typically, each frame has hundreds of chips. The chipping position in a frame can be randomly chosen. For example, FIG. 2 shows Bit 1, on the left, having a chipping position at the commencement of Tc. Bit 0, on the right, has a chipping position after the commencement of Tc, such that the chipping position of Bit 0 is shifted by a fixed amount (δ). This random choice of chipping position also alleviates multi-user interference. However, even under orthogonal chipping sequences, interference will exist due to the asynchronous operation. The pulse modulation can consist of shifted bits or antipodal data bits. A bit can also be transmitted using consecutive pulses to achieve a repetition code.

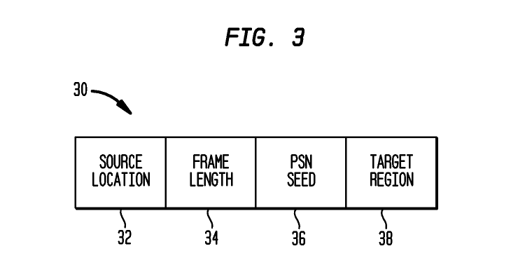

FIG. 3 shows the SYNCH frame 30 initiated by a transmitter or sender 16. The SYNCH frame 30 informs vehicles in a target area to tune to respective THS. An additional purpose of the SYNCH frame 30 is to ensure mutual exclusion by indicating an information target region. FIG. 3 shows the SYNCH frame 30 having a format including a source location 32, a frame length 34, PSN seed 36, and target region 38. This SYNCH frame format is sent on the broadcast time-hopping sequence (THS). The broadcast THS can be derived as a hash of the geographical position or source location 32. The frame length 34 specifies the packet length of the information to be transmitted. The PSN seed 36 is chosen by the sender 16. The target region 38 indicates the sector area where the information is relevant, relative to the sending vehicle 16. This results in a mutually known THS between the senders and the receivers.

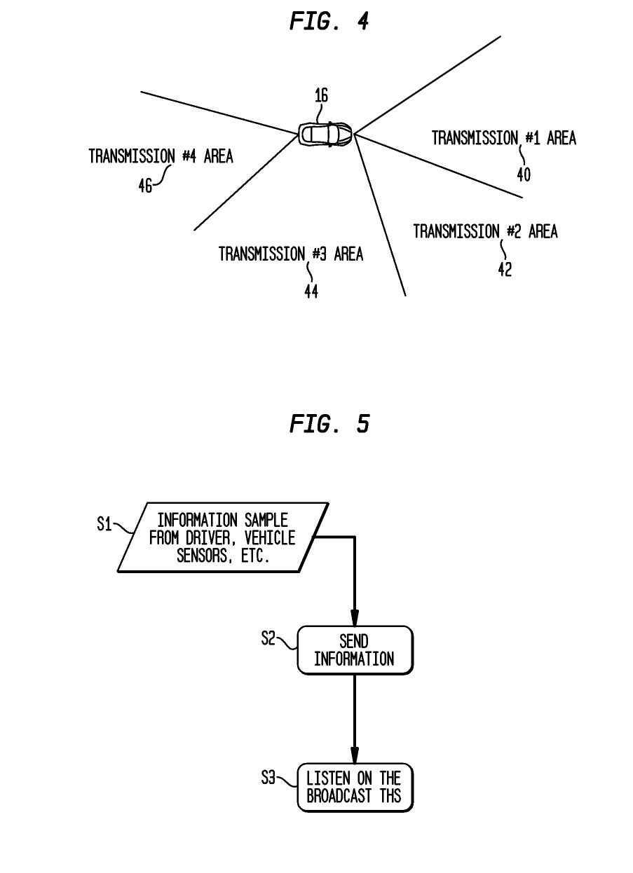

FIG. 4 shows an embodiment of the basic send mechanism of the inventive method, in which a vehicle 16 transmits a message, e.g., the SYNCH frame 30, to transmission areas. In one embodiment, the region around the sending vehicle 16 is divided into the transmission areas. Specifically, the SYNCH frame 30, is initiated and transmitted in a circular fashion repetitively once for each transmission area 40, 42, 44, 46. FIG. 4 shows four transmission areas: transmission area #1 40, transmission area #2 42, transmission area #3 44 and transmission area #4 46. However, the invention is not limited to four transmission areas or sectors; any appropriate number of sectors can be used. Each SYNCH 30 targets the sector 40, 42, 44, 46 relative to the sending vehicle 16. This allows for tight coupling between driving safety information to be disseminated and the region of relevance. The Not Clear to Send (NCTS) option allows a vehicle in a target region to defer the transmission of the sender. If an NCTS or “no-send” is received by the sender within a given time, such as time d, it skips the current area and sends a SYNCH targeted to the next transmission area. The time d may be uniformly and randomly chosen in the range (0, D] to avoid deadlocks. D is a protocol parameter that can vary the degree of concurrency. If an NCTS or “no-send” is not received the information is sent on the chosen THS. This THS can be a mutual or mutually known THS between two or more vehicles.

FIG. 5 is a flow diagram of the overall sending process. In step S1, active-safety information, such as data from a driver, on-board vehicle sensors, GPS systems, etc., is obtained and used to calculate the data, e.g., a source location 32, a frame length 34, and target region 38, placed in SYNCH format by the sending vehicle 16. In step S2, the sender 16 sends the SYNCH message in format 30 and the information. The sending step is discussed further below. In step S3, the sending vehicle 16 listens on the broadcast THS. Nodes, such as vehicles, in the relevant region and/or transmission area 40, 42, 44, 46 receive a SYNCH frame 30 and tune to the THS based on the seed 36, e.g., the chosen THS, in the SYNCH frame or message. Only vehicles tuned to the THS in the relevant sector decode the packet.

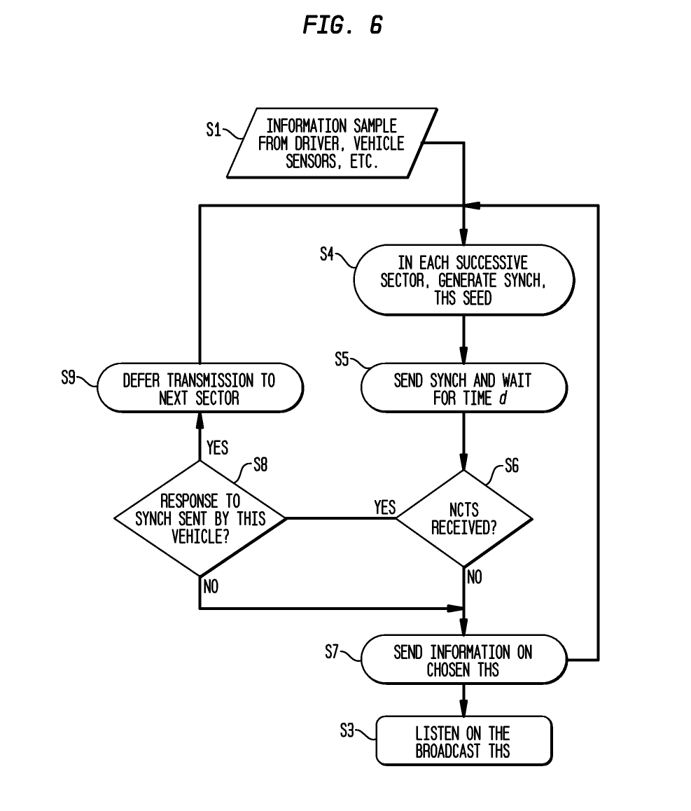

FIG. 6 is a flow diagram of details of the sending process. Note that this sending process is triggered by information sample(s) from a driver, vehicle sensors, etc., as shown in step S1 in FIG. 1. For each successive sector, the following steps are performed. For the sector, in step S4, a SYNCH frame 30 is generated in accordance with the data obtained in step S1. The SYNCH frame 30 is sent to the sector in step S5. If the sender does not receive a no-send or NCTS (S6=NO) after waiting for a time d, then the data is sent on the chosen THS in step S7. The time d may be uniformly and randomly chosen in the range (0, D]. Then the process continues with the next sector of the sending vehicle 16 at step S4.

Otherwise, when an NCTS is received (S6=YES), a determination is made as to whether the NCTS was sent in response to the SYNCH sent by the sending vehicle 16. If not (S8=NO), then the information is sent on the chosen THS in step S7, and processing continues with the next sector at step S4. However, if the NCTS was sent in response to the SYNCH sent by the sending vehicle 16 (S8=YES), the sending vehicle, in step S9, defers transmission of the SYNCH to the next sector. Processing then continues with the next sector at step S4. The receiving procedure is discussed below.

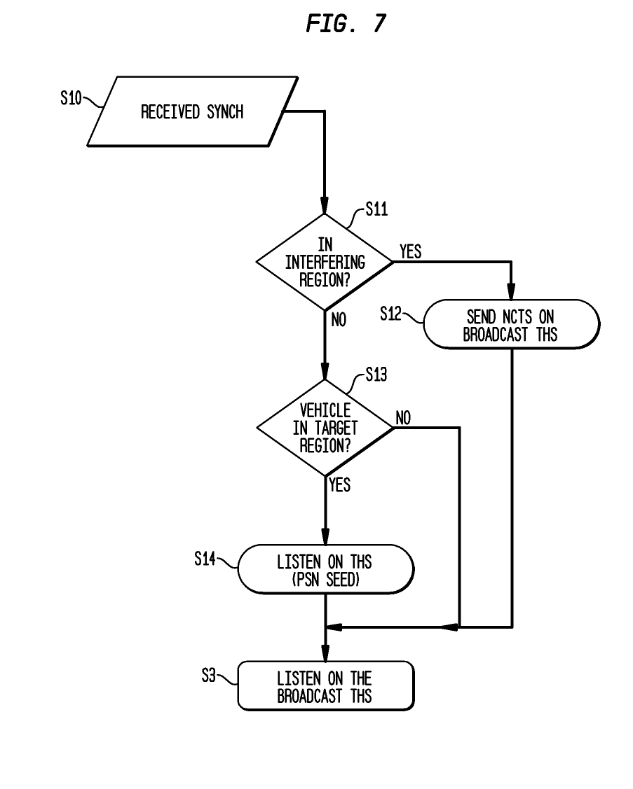

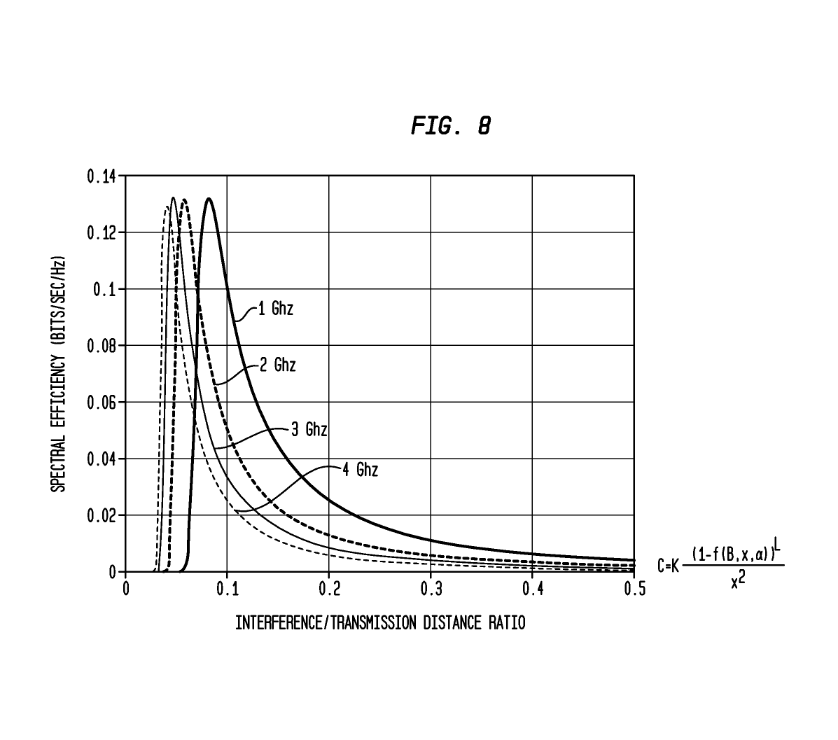

FIG. 7 shows the process at a vehicle, for example vehicle 14, receiving the SYNCH 30. The receiving process is triggered by receiving SYNCH, as shown in step S10. In step S11, first the SYNCH originator's position is determined. If the SYNCH originator is in an interfering region of the current region (S11=YES), then NCTS is sent on the broadcast THS in step S12, and processing continues at step S3, described below.

Otherwise (S11=NO), the SYNCH originator is not in an interfering region. If the sending vehicle is in the target region (S13=YES), i.e. in an area for which the information may be useful to the receiving vehicle, then, in step S14, the vehicle listens on the THS using the PSN seed from the SYNCH frame 30 to receive the information. In step S3, the vehicle listens on the broadcast THS.

However, if the vehicle is not in the target region (S13=NO), then the process continues at step S3 in which the vehicle listens on the broadcast THS.

FIG. 8 shows a heuristic that can be used at vehicles receiving SYNCH to gauge the potential interference caused by the data transmission. The calculation suggests the region around the receiver within which interference is to be avoided. Based on this, generation and transmission of NCTS can limit interference by deferring sender's transmission. A SYNCH generated from a vehicle outside this region could be ignored.

FIG. 8 also illustrates the capacity in the transmission area peaks at certain distances for different system parameters. The plot in FIG. 8 shows the spectral efficiency for different relative distances of the transmitter and the interfering vehicle. Based on the system parameters and the frequency, it is possible to judge the extent of interference at a receiver. The receiver can calculate the region based on information in the SYNCH message and issue an NCTS. The capacity in the transmission area is C, where B is channel bandwidth, L is packet length, α is path loss attenuation, and K is a constant. ƒ is the error function which depends on the signal-to-noise ratio (SNR).

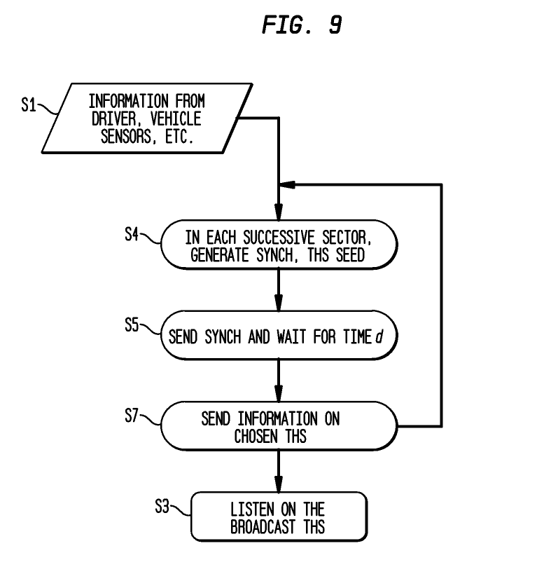

FIG. 9 illustrates the send mechanism without the use of an NCTS option. In FIG. 9, steps similar to those shown in FIGS. 5 and 6 have the same step numbers. This option may be useful for providing a higher data rate under lower densities of vehicles. The process starts in step S1 with a trigger, such as information from Driver and/or from vehicle sensors. For each successive sector, the following steps are performed. For the sector, in step S4, a SYNCH frame 30 is generated in accordance with the THS seed. The SYNCH frame 30 is sent to the sector in step S5 and waits for time d. The time d may be uniformly and randomly chosen in the range (0, D]. The data or information is sent on the chosen THS in step S7. Then the process continues with the next sector of the sending vehicle 16 at step S4. When all sectors have been processed, in step S3, Broadcast THS is listened on.

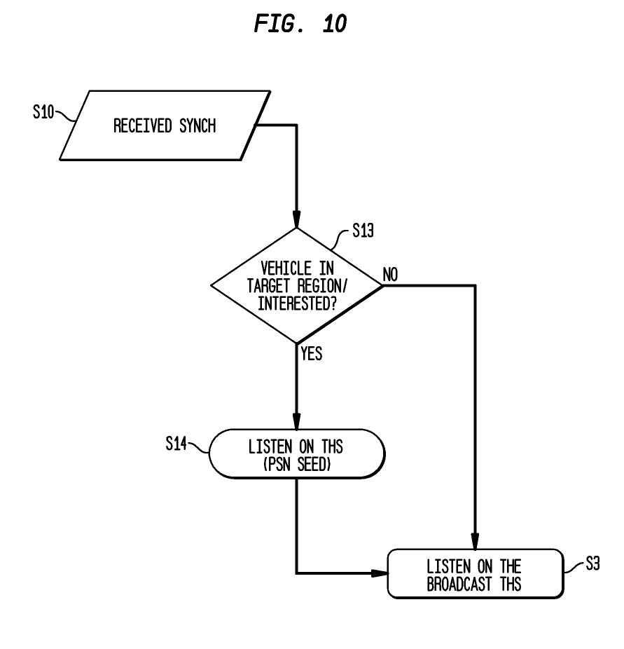

FIG. 10 illustrates the receive mechanism without the use of the NCTS option. In FIG. 10, steps similar to those shown in FIG. 7 have the same step numbers. At step S10, the process at a vehicle, for example vehicle 14, receives the SYNCH 30. If the vehicle is in the target region or the receiving vehicle is interested in the broadcast (S13=YES), then, in step S14, the vehicle listens on the THS using the PSN seed from the SYNCH frame 30 to receive the information. If not (S13=NO), or after the vehicle listens in step S14, Broadcast THS is listened on in step S3.

Some of the advantages of the inventive method include the enablement of interference adaptive vehicular communication, the increase of transmission concurrency, and the ability to address specific vehicular communication requirements such as location-relevance at the physical and medium-access levels.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for increasing transmission concurrency amongst a plurality of communicating vehicles using UWB radio-based communication, comprising steps of:
dividing an area around a sending vehicle of the plurality of communicating vehicles into more than one transmission area;
for each transmission area:
broadcasting a message from the sending vehicle;
waiting for a time; and
after waiting for the time and when a no-send is not received, sending information to the transmission area,
wherein the message comprises at least a location and a seed and the information is sent using a mutual time-hopping sequence based on the location and the seed.

2. The method of claim 1, wherein the message further comprises a frame length and a target region.

3. The method of claim 1, further comprising steps of:
determining, when a no-send is received, whether the no-send was in response to the message from the sending vehicle; and
when the no-send is not in response to the message from the sending vehicle, sending the information to the transmission area.

4. The method of claim 1, wherein the seed is used to generate a sequence of chip positions using a pseudo-random number generator.

5. The method of claim 1, wherein the information is active-safety communication information.

6. The method of claim 1, further comprising a step of obtaining the information by periodically sampling from at least one of a sending vehicle driving system, on-board sensors and units in the sending vehicle, and GPS systems.

7. A system for increasing transmission concurrency amongst communicating vehicles using UWB radio-based communication, comprising:
a sending vehicle of the plurality of communicating vehicles;
a plurality of transmission areas around the sending vehicle;
a message broadcast from the sending vehicle to each of the plurality of transmission areas; and
information sent from the sending vehicle to one of the plurality of transmission areas after waiting for a time and when a no-send is not received at the sending vehicle,
wherein the message comprises at least a location and a seed and the information is sent using a mutual time-hopping sequence based on the location and the seed.

8. The system of claim 7, wherein the message further comprises a frame length and a target region.

9. The system of claim 7, wherein when a no-send is received, determining whether the no-send was in response to the message from the sending vehicle, and when the no-send is not in response to the message from the sending vehicle, the information is sent to the transmission area.

10. The system of claim 7, wherein the seed is used to generate a sequence of chip positions using a pseudo-random number generator.

11. The system of claim 7, wherein the information is active-safety communication information.

12. The system of claim 7, wherein the information is obtained by periodically sampling from at least one of a sending vehicle driving system, on-board sensors and units in the sending vehicle, and GPS systems.

13. A computer readable storage medium storing a program of instructions executable by a machine to perform a method for increasing transmission concurrency amongst a plurality of communicating vehicles using UWB radio-based communication, comprising:
dividing an area around a sending vehicle of the plurality of communicating vehicles into more than one transmission area;
for each transmission area:
broadcasting a message from the sending vehicle;
waiting for a time; and
after waiting for the time and when a no-send is not received, sending information to the transmission area,
wherein the message comprises at least a location and a seed and the information is sent using a mutual time-hopping sequence based on the location and the seed.

14. The computer readable storage medium of claim 13, wherein the message further comprises a frame length and a target region.

15. The computer readable storage medium of claim 13, further comprising steps of:
determining, when a no-send is received, whether the no-send was in response to the message from the sending vehicle; and
when the no-send is not in response to the message from the sending vehicle, sending the information to the transmission area.

16. The computer readable storage medium of claim 13, wherein the seed is used to generate a sequence of chip positions using a pseudo-random number generator.

17. The computer readable storage medium of claim 13, wherein the information is active-safety communication information.

18. The computer readable storage medium of claim 13, further comprising a step of obtaining the information by periodically sampling from at least one of a sending vehicle driving system, on-board sensors and units in the sending vehicle, and GPS systems.
